(19) United States
(12) Patent Application Publication
(10) Pub. No.: US 2014/0095278 A1
(43) Pub. Date: Apr. 3, 2014

(54) METHOD AND SYSTEM FOR TARGETING ADVERTISEMENTS FOR EVENT-BASED SOCIAL NETWORKING

(71) Applicant: MySeat.com Media Inc., Pointe Claire (CA)

(72) Inventors: Normand PIGEON, Cookshire-Eaton (CA); Steven SHELTON, Pointe Claire (CA); Che HODGINS, Verdun (CA)

(73) Assignee: MySeat.com Media Inc., Pointe Claire (CA)

(21) Appl. No.: 14/036,115

(22) Filed: Sep. 25, 2013

Related U.S. Application Data
(60) Provisional application No. 61/709,329, filed on Oct. 3, 2012.

(51) Int. Cl. G06Q 30/02; G06Q 50/00

(52) U.S. Cl. CPC G06Q 30/0252; G06Q 50/01
USPC 705/14.5

(57) ABSTRACT

A social network is associated with an event. The event is joined by individuals who have visibility of others joined to the event via a third party network or via the social network. Demographic data is collected on the individuals joined to the event based on their social behaviour. Demographic patterns are extracted from the demographic data and individuals are targeted for ads based on the demographic patterns.

### FIELD OF THE INVENTION

The invention is related to the field of social networking and more particularly to the field of event based social networking.

### BACKGROUND

Social networking is a term that is applied to World Wide Web sites that incorporate a social aspect into their services. At first, social networking sites allowed for storage and retrieval of personal data beyond merely directory data.

One of the first popular social networking sites was MySpace®. MySpace® allowed users to define a space within the MySpace URL that was personal to the user and reflected user taste, data, and connections. More recently Facebook® has become one of the largest social networking sites in the world. One advantage that Facebook® presented early on was the ability to use the social networking site to arrange social activities. One could post on their wall that they were going to a certain club and their friends would be able to comment—indicate that they were going. It was like telling your friends what you were doing and hearing their replies, but over the Internet instead of in person. Also, it allowed your friends to see each other's replies as if you had invited them all at the end of a class.

Unfortunately, with its wider dissemination, Facebook® has become less a tool for actual interaction and more a tool for virtual interaction. This is not a criticism as much can be accomplished through virtual interaction—photo sharing, messaging, email, status updates, and sharing of personal information, for example. That said, we are social beings and human interaction on a physical and local scale remains desirable.

The term “social networking” is also applied to tools that allow for social communication, such as Twitter® and to other sites/tools that enhance a user's social experience within the World Wide Web. These services maintain a list of social connections and are therefore considered social.

It would, however, be highly beneficial to apply social networking to physical networking and to physical events—events where those socializing are actually present. Unfortunately, none of the existing tools supports a richly featured interactive networking solution.

### SUMMARY OF THE INVENTION

A method comprising joining an event by a first individual having an electronic communication device in communication with a communication network, joining the event other than joining a social network. Gathering individual event data within an event timeline, the individual event data in relation to the event and the first individual. Storing the individual event data in a data store in relation to the first individual and the event timeline. Based on the individual event data in the data store, retrieving advertisements from a server in communication with the communication network, the server having access to the individual event data in the data store and providing the advertisements to the electronic communication device and directed toward the first individual.

A method comprising joining an event by a first individual having a first electronic communication device in communication with a communication network. joining the event by a second individual having a second electronic communication device in communication with the communication network. Based on event data within an event data store, retrieving advertisements from a server in communication with the communication network, the server having access to the event data, the advertisements based on at least event data relating to the second individual and transmitting the advertisements to the first electronic communication device of the first user.

A method comprising: receiving by a server data relating to an event. Receiving by the server data related to individuals who have joined the event. Storing by the server data relating to the event and the individuals in relation one to the other. Mining the data to extract patterns therein, the patterns indicative of at least one of demographics and advertising/sales opportunities and storing data in relation to the individual relating to the extracted patterns.

A method comprising: providing a piece of memorabilia relating to a specific event. Entering electronic data relating to the availability of the piece of memorabilia into a first electronic device in communication with a communications network. Transmitting the electronic data from the first electronic device to at least one of a plurality of electronic devices via the communication network. Receiving by the first electronic device an offer to acquire the piece of memorabilia from the one of the at least one of a plurality of electronic devices. Transmitting to the one of the at least one of a plurality of electronic devices an acceptance of the offer and performing one of: transmitting to the at least one electronic device data for acquiring the piece of memorabilia and transmitting data to the first electronic device, the data used for delivering the acquired piece of memorabilia.

A method comprising receiving by a server data relating to an event. Receiving by the server data related to individuals who have joined the event. Storing by the server data relating to the event and the individuals in relation one to the other. Mining the data to extract patterns therein, the patterns indicative of social behaviours of the individuals and assigning tickets to individuals within a group comprising a plurality of friends, the tickets assigned in dependence upon the results of mining the data.

### BRIEF DESCRIPTION OF THE FIGURES

FIG. 1 is a simplified diagram of a social network according to the prior art.

FIG. 2 is a simplified diagram of a social network according to an embodiment of the invention.

FIG. 3 is a simplified diagram of a social network wherein events are joined by individuals.

FIG. 4 is another simplified diagram of a social network wherein events are joined by individuals.

FIG. 5 is a simplified diagram of a timeline according to an embodiment of the invention.

FIG. 6 is another simplified diagram of a timeline according to an embodiment of the invention.

FIG. 7 is another simplified diagram of a timeline according to an embodiment of the invention.

FIG. 8 is a simplified diagram of a portion of a first timeline merged with a second timeline.

FIG. 9 is a simplified diagram of a timeline merged with the entirety of a second timeline.

FIG. 10 is a simplified diagram of a super timeline according to an embodiment of the invention.

FIG. 11 a simplified diagram of a traceable timeline according to an embodiment of the invention.

FIG. 12 is a simplified block diagram of timeline experiences shared with third party social media networks.

FIG. 13 is another simplified diagram of a timeline according to an embodiment of the invention.

FIG. 14 is a simplified block diagram of an individual checking into an event.

FIG. 15 is a simplified block diagram of another individual checking into an event.

FIG. 16 is a simplified block diagram of an individual joined into an event from a location other than the event location.

FIG. 17 is a simplified block diagram of an individual checked into an event according to an embodiment of the invention.

FIG. 18 is a simplified diagram of an individual and the individual's network of friends checked into an event.

FIG. 19 is a simplified diagram of a page from an individual's third party social network.

FIG. 20 is a simplified diagram of a wedding timeline according to an embodiment of the invention.

FIG. 21 is a simplified diagram of an individual and the individual's network of friends.

### DETAILED DESCRIPTION OF EMBODIMENTS OF THE INVENTION

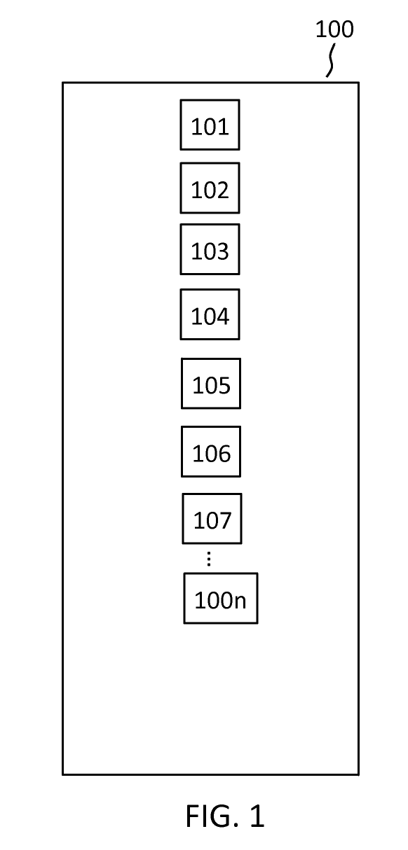

Referring to FIG. 1, shown is a simplified diagram of a social network according to the prior art. A user has provided their personal information including preferences, likes and dislikes. They have also linked up with a number of friends and have a “wall” on which friends post notes and messages. A news feed tells the individual what has been placed on peoples walls, what statuses people have provided, and highlights other noteworthy events that users linked to the individual, “friends,” have entered into their “page.” For example, the user's Facebook® page 100 shows the following posts: Gordon the user joins Facebook® at 101; Gordon friended Sue at 102; Gordon is married to Rashell at 103; Gordon likes Ashley's cupcakes at 104; Gordon is going to the hockey game at 105; Gordon likes summer at 106; Gordon is feeling tired all day at 107; Gordon friended John at 108; and Ashley's Cupcakes has a special today at 100n.

Unfortunately, the social network of FIG. 1 relates to data entry of individuals and fails to adequately provide real life social experiences involving two or more people sharing an event together.

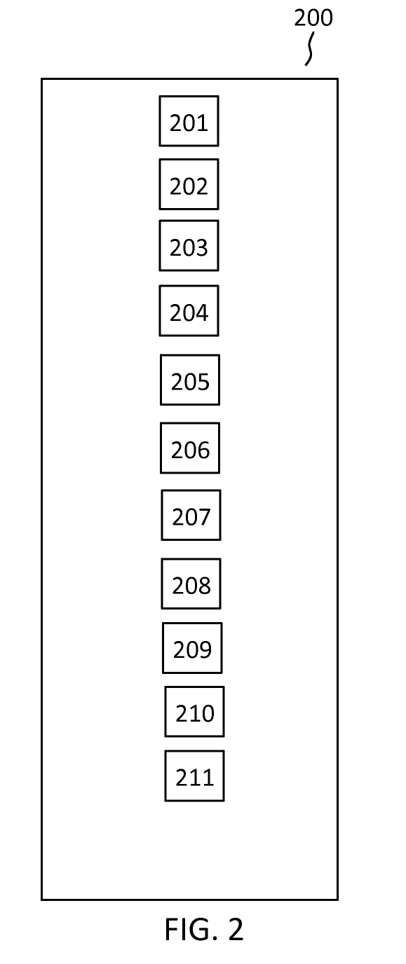

Referring now to FIG. 2, shown is a simplified diagram of a social network according to an embodiment of the invention. Here, an individual is linked to a number of “friends.” This, for example, is accomplished via the social network of FIG. 1, an existing third party social network, or a social network specific for the present purpose. When the individual attends an event, for example a sporting event, the individual is notified of linked individuals who are also present at the sporting event. In this way, the individuals share the event and can socialize with each other during the event. For example, the individual's Facebook® page 200 shows the following posts: Gordon joins Facebook® 201; Gordon friended Sue 202; Gordon is married to Rashell 203; Gordon likes Ashley's cupcakes 204; Gordon is going to the hockey game on November 15th 205; Gordon likes summer 206; Gordon is feeling tired all day 207; Gordon friended John 208. The next item posted on Gordon's Facebook® page, Gordon arrived at the hockey game 209, is automatically generated when Gordon's ticket is scanned upon entry at the hockey game. Furthermore when Gordon's friends arrive at the hockey game, and their tickets are scanned, the posts, Rashell arrived at the hockey game 210; and John arrived at the hockey game 211 are automatically generated and posted on Gordon's Facebook® wall. Gordon now knows that his friends Rashell and John are attending the same game as him and Gordon can contact them to get together immediately after the game for drinks.

Alternatively, the post, Gordon has arrived at the hockey game 209 is automatically posted when the GPS in Gordon's smartphone detects that he has entered the hockey arena. Further alternatively, the post, Gordon has arrived at the hockey game 209 is automatically posted when Gordon enters data into a software program indicating his arrival at the hockey arena.

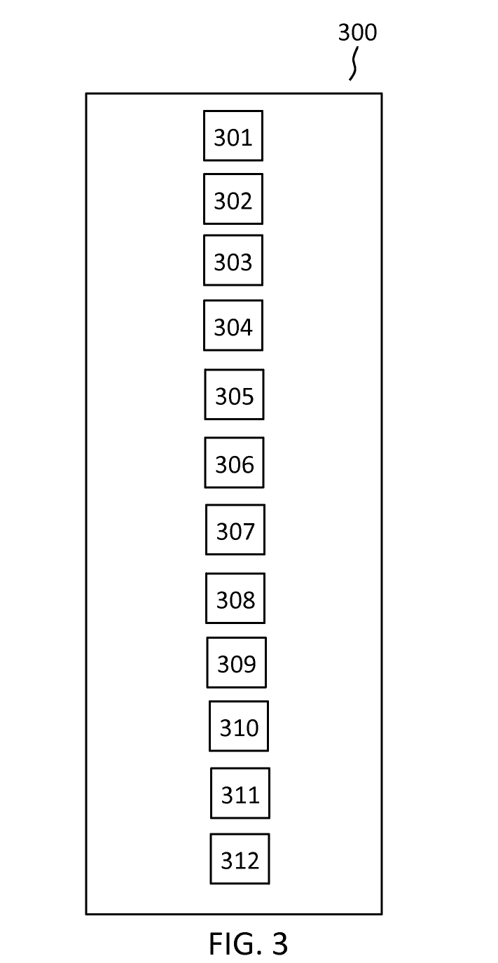

Referring to FIG. 3, shown is a simplified diagram of a social network according to another embodiment wherein timelines are created and individuals join events. A timeline is created and an event is joined when an individual arrives at a venue related to the event. For example, when the individual arrives at a hockey arena to watch a hockey game. The individual's Facebook page shows the following posts: Gordon joins Facebook® 301; Gordon friended Sue 302; Gordon is married to Rashell 303; Gordon likes Ashley's cupcakes 304; Gordon is going to the hockey game on November 15th 305; Gordon likes summer 306; Rashell is going to the hockey game 307; Gordon is feeling tired all day 308; and Gordon friended John 309. The next item posted on Gordon's Facebook® page, Gordon arrived at the hockey game 310 is automatically generated when Gordon's ticket is scanned upon entry at the hockey game. Furthermore, an event timeline, in this example the hockey game timeline, is created and Gordon joins the hockey game event. When Gordon's friends arrive at the hockey game and their tickets are scanned, the posts, Rashell arrived at the hockey game 311 and John arrived at the hockey game 312 are automatically generated and posted on Gordon's Facebook® wall and within Gordon's event timeline for the hockey game. Timelines for both Rashell and John are created and Rashell and John each join their own hockey game event.

Alternatively, timelines are generated and events are joined when the GPS in an individual's smartphone detects that the individual has arrived at the event venue. Further alternatively, timelines are generated and events are joined when the individual enters data into a software program indicating their arrival at the event venue.

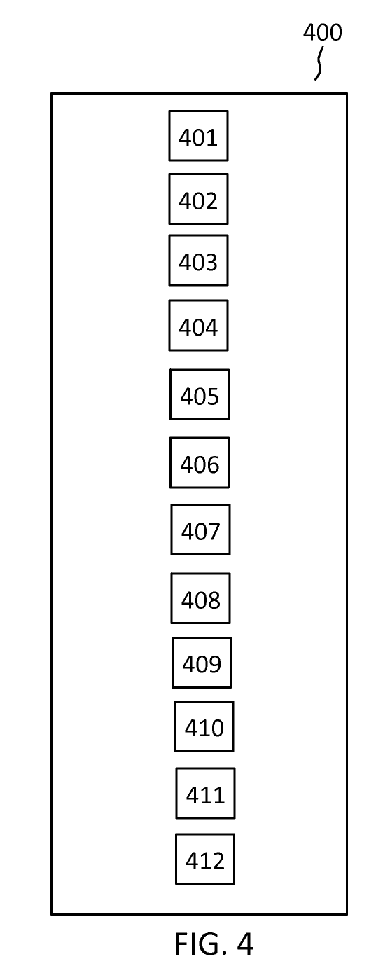

Referring to FIG. 4, shown is a simplified diagram of a social network according to another embodiment of the invention wherein individuals join events. An event is joined when an individual decides to attend. The individual is then notified of linked individuals that are also planning to attend the event. For example, when an individual buys their tickets for a sporting event, the individual joins the event. Now the individual can see who amongst their linked “friends” is planning on attending the event and can arrange with them to socialize during the event, before the event, or after the event. Further, the individuals can plan follow up get-togethers—for example meet up to talk about the event when we get back if the sporting event is somewhere else. The individual's Facebook page shows the following posts: Gordon, joins Facebook® 401; Gordon friended Sue 402; Gordon is married to Rashell 403; and Gordon likes Ashley's cupcakes 404. The next item posted on Gordon's Facebook® page, Gordon is going to the hockey game on November 15th 405, is automatically generated when Gordon's ticket is scanned or photographed, for example, by his smartphone. Furthermore, an event timeline, in this example, a hockey game timeline, is created and Gordon joins the hockey game event. The following post, Rashell is going to the same hockey game 407, is automatically generated when Rashell's ticket is scanned or photographed, for example, by her smartphone. Furthermore, an event timeline, in this example, the hockey game timeline, is created and Rashell joins the hockey game event. Other posts include Gordon likes summer 406; Gordon is feeling tired all day 408; Gordon friended John 409 and Gordon arrived at the hockey game 410; When Gordon arrives at the hockey game his ticket is scanned and he “checks into” the hockey game event. Checking into the event occurs when the individual arrives at the event venue. The next post, Rashell arrived at the hockey game 411; indicates that she has also “checked into” the hockey game event. The next post, John arrived at the hockey game 412, is automatically generated when John's ticket is scanned upon entry at the hockey game. Furthermore, an event timeline, in this example, the hockey game timeline, is created, and John joins and “checks into” the hockey game event.

Alternatively, check in occurs when the GPS in an individual's smartphone detects that the individual has arrived at the event venue. Further alternatively, timelines are generated and events are joined when the individual enters data into a software program indicating that he is intending to attend the event. Alternatively, an individual checks into an event when the individual enters data into a software program indicating his arrival at the event venue.

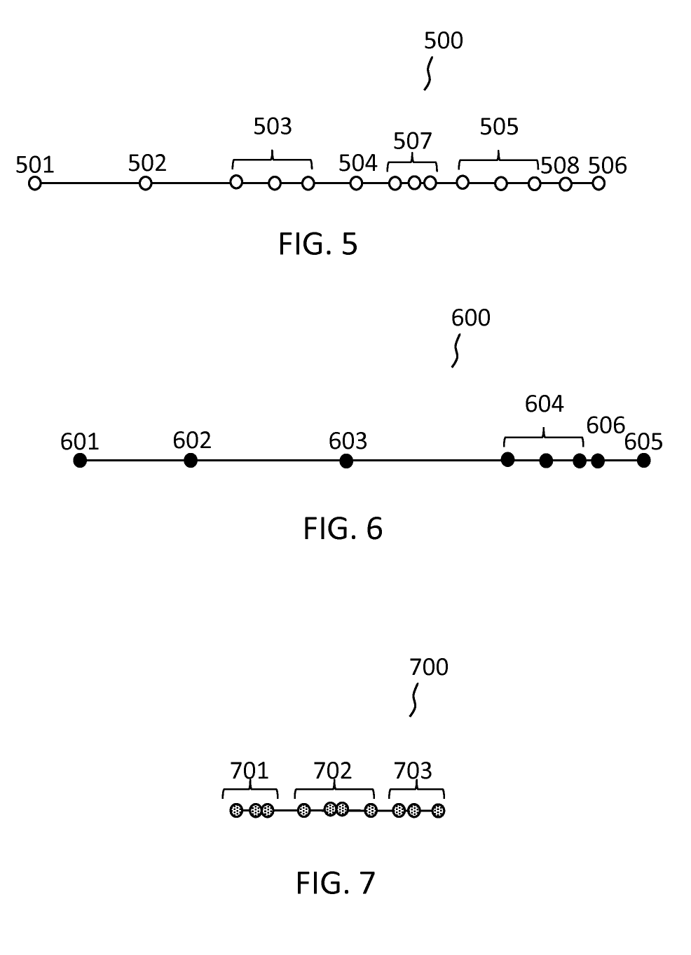

Shown in FIG. 5 is a simplified diagram of a timeline according to an embodiment. Timeline 500 relates to a single event, for example a sporting event. Timeline 500 is made up of sequenced experiences—sequential in time—relating to an individual.

For example, on November 1^{st}, the individual bought a ticket to a November 15th hockey game. The individual scans the ticket's bar code and joins the event, timeline 500 for the hockey game is created and a first experience 501 is entered into timeline 500. Though created on November 1^{st}, timeline 500 relates to an event on November 15^{th}—the hockey game. The individual, on November 6^{th}, enters into the timeline the fact that he will celebrate or mourn the game's outcome at a sport bar near the rink after the game 502. This entry is posted on the individual's third party social networking website and friends linked to this individual, via the third party social networking website, see that he is attending. Three of his friends who are also going to the game make contact with him. Alternatively, when his friends scan their tickets and join the event the individual sees that his friends have arrived at the event venue. and immediately contacts them. For the next 5 days several communications 503 regarding making plans for the game are shared between the four friends and each communication is entered into timeline 500. The table at the sports bar is reserved on November 10^{th} 504 and the arrangements are made. Entries on the day of the game relating to preparing for the game, car-pooling to the game and arriving at the game are added to the timeline 500 at 507.

Each experience is logged in the individual's timeline 500 according to the time and date that the experience occurred. On November 15^{th}, during the event, game related experiences 505 are entered into timeline 500. Finally, once the game is done, the timeline transitions to the post game events at the sport bar 508 and concludes with the individual arriving home 506. Upon reviewing the timeline, it captures the user's experiences of a single sporting event. The individual views his event timeline 500 on a smartphone, tablet or computer screen. The experiences are presented in a sequential fashion such that they are organized according to the day and time they were entered into timeline 500.

Alternatively, the timeline is created when the individual joins the event via a software program.

Now referring to FIG. 6, shown is another event timeline 600 relating to the same hockey game of November 15^{th}, but for another member of the group of four individuals that car-pooled together. Timeline 600 is very similar to timeline 500, but the actual entries differ. For example, the ticket was purchased on June 5^{th} 601 as opposed to November 1^{st}. Other experiences in timeline 600 include pictures of the friend wearing the home team's jersey on November 7^{th} 602, commentary he made predicting the outcome of the game on November 11^{th} 603, and pictures he took during the game 604. Finally, once the game is done, the timeline transitions to the post game events at the sport bar 606 and concludes with the friend arriving home 605. Optionally, the experiences that he shared with the individual are also included in timeline 600, for example correspondence between the four friends such as that shown at 503 in FIG. 5 (not shown for clarity).

Now referring to FIG. 7, shown is a simplified diagram of another event timeline 700, but this time referring to the actual sporting event. Here, sporting event entries are seen as they have been entered, for example by a newsman working the event. For example, 30 minutes before the game the newsman gives a commentary 701 of the line-up for the game, injured players, and a recap of the last game the playing teams played. During the game 702, the newsman comments on goals, team performance, plays and provides related video. After the game 703, the newsman provides a commentary on the score of the game, most valuable player and other highlights of the game. Though these experiences are not all shown in the timelines of FIGS. 5 and 6, the individuals at the game were privy to most if not all of the same happenings within the game.

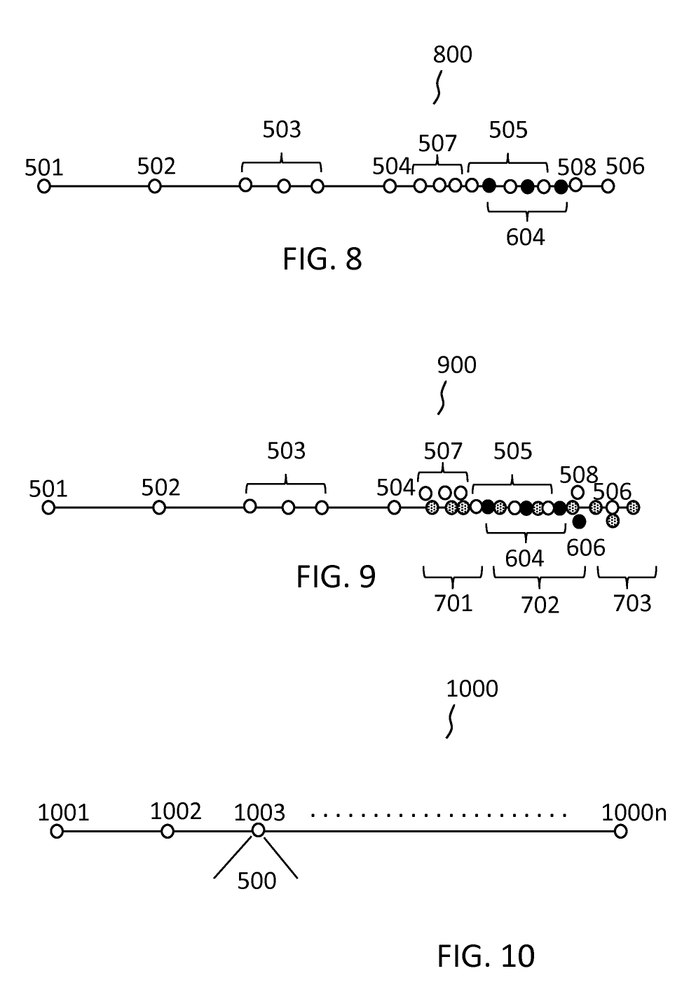

Now referring to FIG. 8, shown is a simplified diagram of a portion of timeline 600 merged with timeline 500. For example, the first individual would like to include the pictures that his friend took at the game that are entered into timeline 600. However, he does not wish to include his friend's entire timeline. Once the first individual's friend shares his timeline with the first individual, the first individual selects a portion of the timeline 600 to overlay on top of timeline 500. The portion the first individual selects is at 604 of timeline 600, which contains pictures of the game. The first individual views timeline 800 on a smartphone, tablet or computer screen. The timeline 500 and timeline 600 remain separately stored allowing for viewing of each separately or combined. The experiences are presented in a sequential fashion such that they are organized according to the day and time they were entered into their original timelines.

Alternatively, the first individual selects only the pictures experiences that the first individual likes the best and merges those with timeline 500. Further alternatively, the first individual merges the entire timeline 600 with timeline 500.

Referring to FIG. 9, shown is a simplified diagram of timeline 700 merged with the entire timeline 800. The newsman's timeline is publicly available and can be merged with anyone's timeline. Now the news of the game is inserted within the timeline of the first individual, and a portion of the timeline of the second individual, showing their experiences and the game happenings in a single combined timeline. Of course, the three timelines remain separately stored allowing for viewing of each separately or combined. Since both the individuals shared the game experience, they share some common timeline experiences but each timeline is different. For example, if the second individual caught a puck they would add a comment to their timeline. That clearly did not happen in the general news or to the first individual.

Once the event is over and timeline 900 has ended, the first individual has the ability to view timeline 900 at any time in the future. Optionally, the first individual adds experiences to his timeline line after the timeline is completed. For example, the first individual adds to timeline 500 a picture of the player that scores a goal, at the time the goal is scored. Furthermore, after the event is closed, the first individual merges a second friend's timeline with timeline 900 and first individual views the four timelines merged together. Alternatively, the first individual other than merges the second friend's timeline with timeline 900 and views the second friend's timeline separately. Further alternatively, the first individual removes the portion of timeline 600 from the timeline 900 and views timeline 500 merged with timeline 700.

Shown in FIG. 10 is a simplified diagram of a super timeline according to an embodiment of the invention. A super timeline is associated with an event that comprises multiple sub-events. Each sub-event is associated with its own timeline. A specific and non-limiting example is a hockey season event associated with super timeline 1000. The hockey season event comprises sub-events such as hockey games 1001, 1002, 1003, . . . 1000n and each hockey game has its own timeline. For example, sub-event 1003 is the hockey game that the first individual attended on November 15th and is associated with timeline 500. The first individual also attended hockey games 1001, 1002, . . . 1000n and each sub-event has corresponding timelines. The first individual views timeline 1000 on a smartphone, tablet or computer screen. The first individual can also view each sub-event timeline. The sub-events and experiences are presented in a sequential fashion such that they are organized according to the day and time they were entered into timeline 1000. Alternatively, another ordering methodology is employed.

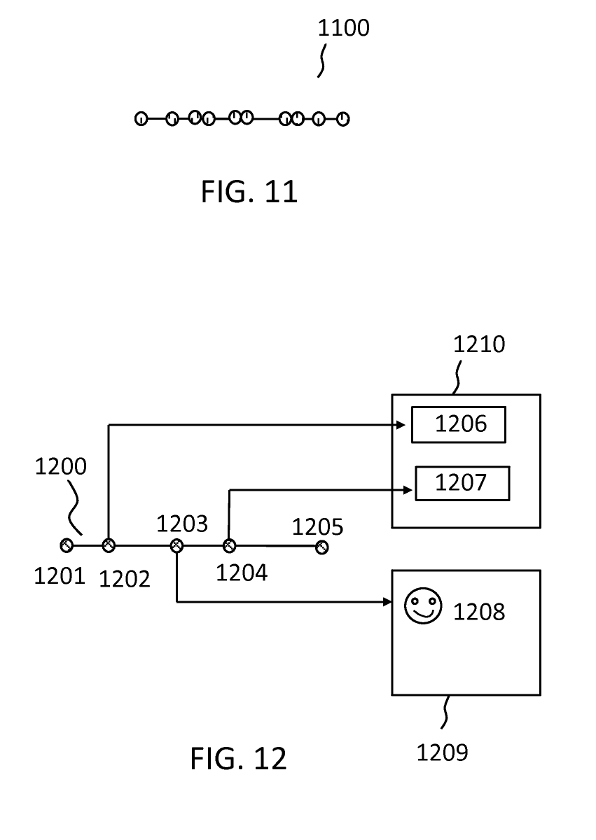

Referring to FIG. 11, shown is a simplified diagram of a traceable timeline according to an embodiment of the invention. A traceable timeline is a timeline that is automatically generated based on activity of the user, yet not entered into the timeline by the user. A specific and non-limiting example is credit card timeline 1100. During the hockey event on November 15^{th} the first individual made several purchases with his credit card, such as his ticket, beer before the game, popcorn during the first intermission, a home team jersey during the second intermission, beer at the sports bar, etc. When the first individual receives his credit card bill, the first individual does not recall all of the purchases indicated on the bill during the hockey game event and wonders if some of the purchases are invalid. To jog his memory the first individual overlays the credit card timeline 1100 onto timeline 900 and reviews the merged timelines on either a smart phone, tablet or personal computer screen. As the purchases are now visible and in sequence with the experiences of timeline 900, viewing the merged timelines aids him in recalling the purchases on his bill.

According to an embodiment, timelines are instantaneously merged. For example, instead of the first individual merging the newsman's timeline 700 with timeline 800 after the event is over, he selects the newsman's timeline for real time merging with his own timeline 500. Doing so allows the first individual visibility of the newsman's experiences as soon as they are entered into timeline 700.

Now referring to FIG. 12, shown is a simplified block diagram of timeline experiences shared with third party social media networks. Timeline 1200 is associated with an event, a specific and non-limiting example is a music concert. A first individual has accounts with third party social media networks, for example Twitter® 1210 and Facebook® 1209. The event timeline begins at 1201 when the first individual purchases her ticket and joins the event. Her ticket is scanned at the entrance and she is checked into the concert at 1202. Alternatively, the first individual checks into the concert by entering data into a software program. Further alternatively, the first individual is checked into the event when the first individual arrives at the event venue. The experience of arriving at the concert is not only entered into timeline 1200 but also posted as a tweet 1206 on her Twitter® account 1210. The next experience entered into her timeline is a picture the first individual takes of her friends 1203, which is then automatically posted on her Facebook® page 1208. At 1204 the first individual enters a comment about the band into timeline 1200 which is posted as a Tweet 1208 on her Twitter® account 1210. Not all of her experiences are shared with the third party social media networks, for example, purchasing her ticket at 1201 and the end of the concert at 1205 are entered as experiences in timeline 1200 but not posted on Twitter® or Facebook®. Alternatively, entries by the first individual into third party social media sites are incorporated into timeline 1200. For example, tweets that the first individual sends out during the event are entered into timeline 1200 as sequenced experiences. Further alternatively, any new entries into her Facebook® that occur during the event are also entered into timeline 1200 as sequenced events.

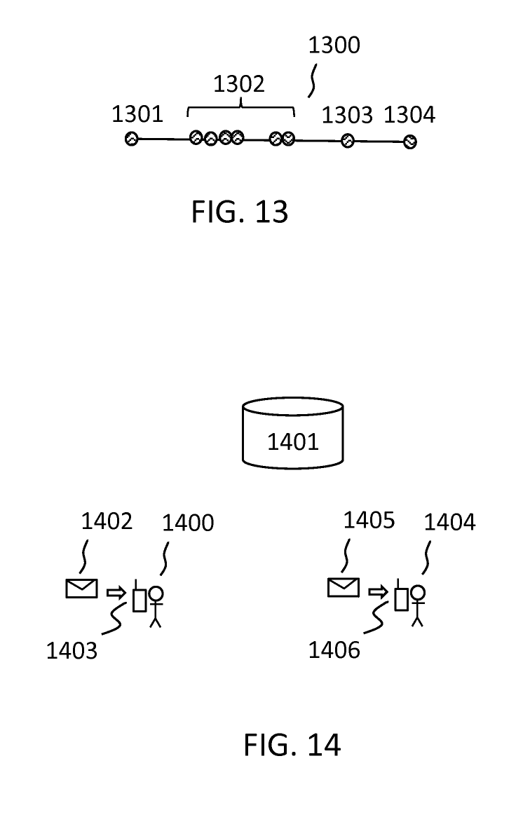

Shown in FIG. 13 is another simplified diagram of a timeline. A friend of the first individual described in the example of FIG. 12 is unable to attend the concert in person, however she plans to watch the live concert on TV. Timeline 1300 is created when the first individual joins the concert 1301 by entering data into a software program. The friend sees that the first individual has joined the event, and during the concert exchanges text messages with her 1302 and they decide to share their timelines with each other 1303. Finally, the concert ends 1304 as does timeline 1300.

The following are examples of ways to check into an event: an event ticket is scanned using an electronic device and ticket information is provided to the individual's timeline, a person enters data via a media interface into a software program.

According to an embodiment of the invention, users of an event social network are targeted for ads based on various aspects of their participation in the event. For example, shown in FIG. 14 is a first individual 1400 who checks into an event by scanning his ticket, in this case the event is a NBA basketball game. His seat information is entered into his timeline and is available to the social network and his friends. The first individual's seat information is also stored in a social network data store 1401 wherein demographic information is kept for user's who join events. The first individual's seat is courtside, one of the best seats in the house. Based on the high cost of the ticket, the first individual receives advertisements via messages or emails 1402, for example on his mobile device 1403, that are intended for individuals that can afford courtside seats to a NBA basketball game. For example, based on the demographic information stored in the social data network store 1401, the first individual is emailed ads for high-end restaurants close to the game venue and other ads for designer clothing. A second individual 1404 also checks into the game by scanning his ticket and the second individual is seated in the nosebleed section. The second individual's seat information is entered into his timeline and is available to the social network and his friends. The second individual's seat information is also stored in a social network data store 1401 wherein demographic information is kept for user's who join events. Based on the demographic information stored in the social data network store, the second individual is also targeted with advertisements and receives emails 1405, for example on his mobile device 1406, however the emails are from local sports bars and for last minute travel deals. The category of advertisements, coupons and other marketing material sent to individuals is based on the perceived relative spending of the individuals. Further, knowledge of the cost of the seat and the type of event is also useful in targeting messages, offerings and promotions. For example, a charity in conjunction with the sports team offers access to the locker room before or after the game based on some charitable donation. The offer is likely to be more effective depending on the price of the seats. It is note worthy that the same ads advertised to the high-end market are not as desirable to the low-end market. As such, dividing the messages amongst different demographics and seating behaviour is an effective method for advertising. In another example, the first individual enters into his timeline that he used valet parking whereas the second individual enters that he took the bus to the game. The first individual receives luxury car ads while the second individual receives economy cars ads. Of further note, data relating to the first and second individual is also retrievable—minable—from other social network data stores such as other social networks that the individuals are members of. Further optionally, data relating to other events and other event participation of the individuals is analyzed in determining a suitable advertisement or offer.

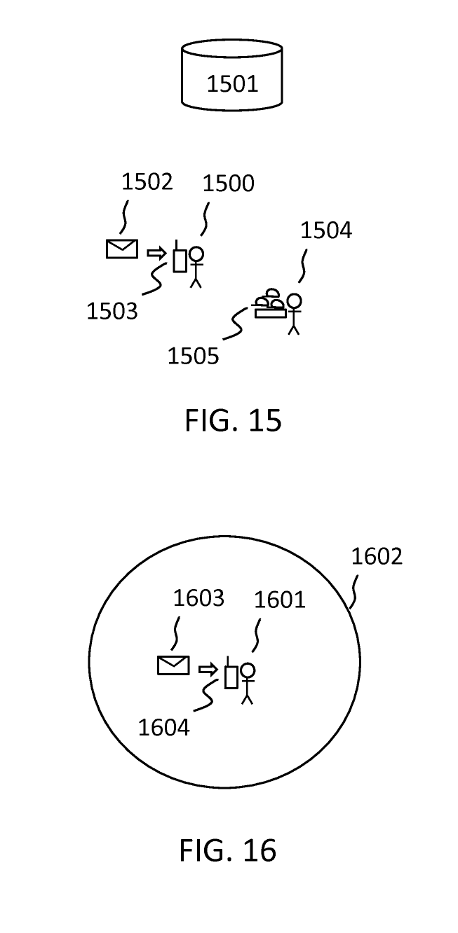

Shown in FIG. 15 is a first individual 1500 at a baseball game. The first individual joins the baseball game event and checks into the baseball game event. His seat information is entered into his timeline, which is available to the social network data store 1501 and his friends. The first individual is a hard-core fan of the home team and has regularly purchased home team paraphernalia when he attends games. His purchasing information from previous games has been stored in the event timeline of the social network data store 1501 and the first individual is flagged as someone to whom to advertise team products. A new home team baseball hat is on the market and the individual receives a communication, for example, an email 1502 on his mobile device 1503, enabling him to purchase this new hat online, which he does. Furthermore, his purchase online is stored in the event social network data store 1501. Alternatively, a venue employee 1504 selling the new hats 1505 visits him and sells him the hat in person. The new purchase is added into his timeline and is logged into the event social network data store.

Some experiences in a timeline are automatically generated and added, for example seat information is optionally automatically entered into a timeline when an individual's ticket is scanned. Other experiences include, among other things, communications between friends. As experiences are added to an individual's timeline they are analyzed for data and key words. This information is then stored and later used to target ads towards users of the event social network. Furthermore, experiences from overlaid timelines, for example traceable timelines, are also analyzed.

Optionally, a traceable timeline is overlaid onto the individual's timeline. For example, the traceable timeline is the individual's credit card timeline. Any purchases made with the credit card during the event is logged into the social network data store and is used for future ad targeting.

During the baseball game, game memorabilia is put up for auction. Fans with a history of purchasing team paraphernalia are invited to participate in the auction. The fans that are seated in the more expensive seats are also invited to participate as bidding prices for items such as signed jerseys and balls can reach a value that is likely more affordable to high-end consumers. Alternatively, an individual has created a fan club for the home team on the event social network, which is entered into his timeline and is available to the social network data store and his friends. He notes that his favorite player is number 16 and he has listed all of number 16's stats in his fan club “page.” During the game, number 16 hits a home run and the ball is put up for auction soon afterwards. The information in the individual's fan club page indicates that he may be interested in bidding on number 16's home run ball. The individual receives an invitation to bid on the ball via email or some other sort of messaging. Furthermore, any bidding by the individual is stored in the event social network data store. Further alternatively, the individual mentions number 16 in several of his communications with his friends during the baseball game. This information also indicates that he may be interested in bidding on number 16's home run ball.

Advantageously, selection of potential buyers for memorabilia allows for selling and offering of more memorabilia each item to a different group of individuals such that many auctions are supported either in series or at different times without disrupting the event for those attending or who have joined. In another embodiment, the items to be sold at the event are selected based on data relating to those in attendance, their preferences, and their spending habits such that some memorabilia are auctioned to the entire event audience, while other items are selected for private group auctions or for being offered at a fix price either during the event or afterward. Further advantageously, some memorabilia is such because of the event experiences that occur. For example, if someone proposes to his now fiancé at a football game, perhaps he would be interested in owning the game ball. Of course, many other examples of statistically relevant and personally relevant experiences are possible.

In an embodiment, live memorabilia is created during the event. Specific and non-limiting examples of live memorabilia include, photographs taken at the event, photographs taken at the event and signed by performers or athletes, photographs taken at the event and signed by performers or athletes including a special message from the performer or athlete, and an event-used specific item. Certain events or event moments have special meaning to certain individuals attending an event. For example, a home run performed by a favorite baseball player of an individual. The home run baseball is signed by the favorite baseball player specifically for the individual including a message to the individual. The individual purchases the baseball during or after the baseball game. Another specific and non-limiting example is that a baseball game is a special event for a young fan—it is the first baseball game he has ever attended. Live memorabilia such as a signed jersey by a baseball player on his favorite team, would be of great value to the young fan. The young fan purchases the signed jersey during or after the baseball game.

Referring to FIG. 16, shown is an individual 1601 joined to an event, in the form of a NFL football game, from a sports bar 1602. Each time the home team plays, the individual sits at the bar of the sports bar and watches the game on TV. He is a good customer and to keep his business the sports bar sends him coupons and notifies him of specials via the event social network. For example he receives emails 1603 via the event social network on his mobile device 1604. One evening he does not arrive at the sport bar to watch the game. The sports bar reserves a seat for him at the bar in anticipation of his arrival. Optionally, the GPS in his smartphone is detected to be near the sports bar and informs the sports bar of such. The bartender assumes the customer is on his way to the sports bar and reserves a seat for him. Alternatively, the individual is messaged to determine if he would like to have his regular seat saved.

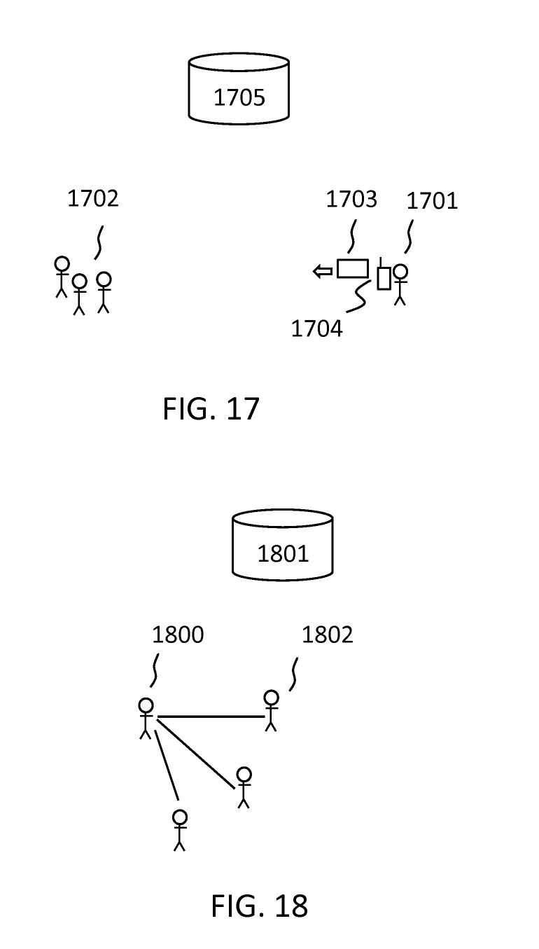

Referring to FIG. 17, shown is an individual 1701 joined and checked into an event in the form of a baseball game. The individual has other friends 1702 also attending the baseball game, however they are not sitting together. Each time the individual goes to the bar to purchase a beer he sends a communication, for example a text message 1703 from his mobile device, 1704 to his friends inviting them to meet him at the bar. The communications between friends are analyzed and the frequency of his trips to the bar are logged into the event social network data store 1705. Alternatively, a traceable timeline is overlaid onto the individual's timeline. For example, the traceable timeline is the individual's credit card timeline. The frequent purchases made at the bar are logged into the event social network data store 1705. The individual is noted to be a good customer at the bar and he receives beer ads and bar promotions during the baseball game, for example in emails received by his mobile device. Optionally, a venue employee selling beer visits him to save him the trip of going to the bar. Further optionally, this type of data is used to determine patrons who are most profitable to a venue and is then used to communicate with those patrons to encourage them to attend further events at the venue.

According to an embodiment of the invention, event social network data is collected for many events and is used for cross event sales. For example the individual discussed in the example of FIG. 17 joins and checks into another event, this time a rock concert. His past beer purchasing history from previous events, such as the above mentioned baseball game, indicates that he is a good target for beer ads and bar sales promotions. During the rock concert he receives relevant advertisements and offers. Optionally, a venue employee selling beer visits him to save him the trip of going to the bar.

According to an embodiment, users of an event social network are targeted for ads based on various aspects of their friend's participation in the event. For example, shown in FIG. 18 is an individual 1800 and his network of friends 1802. Individual 1801 checks into an event in the form of an NBA basketball game by scanning his ticket. His seat information is entered into his timeline and is available to the social network data store 1801 and his friends 1802. His seat is courtside, one of the best seats in the house. His friends 1802 also check into the basketball game by scanning their tickets. Their seat information is entered into their timelines and is available to the social network data store 1801 and their friends. Unlike the individual, his friends 1802 are seated in the nosebleed seats. Although the individual 1801 is seated in expensive seats his association with his friends 1802 in the much less expensive seats affect the types of ads he receives. For example, the category of advertisements, coupons and other marketing material sent to individuals is based on the perceived relative spending of their network of friends. Instead of receiving advertisements for high-end restaurants and services for after the game, he receives advertisements for restaurants that are more indicative of the price range afforded by those occupying the seats his friends occupy or middle ground therebetween. This is most relevant when the advertisements or offers relate to group activities, for example sport bars. Similarly, depending on past behaviour the offers are further tailored. When the individual has gone out after the game with those friends on 50% of past games, then it is more important to maintain the ads in accordance with that fact. If the individual never goes out before or after the game with those individuals, then correlating the advertisements to the friends seat selection is less significant.

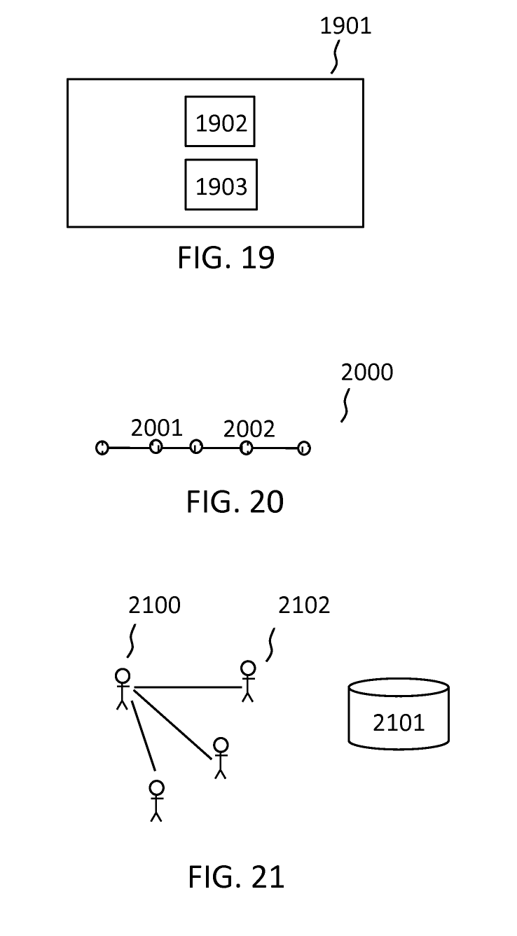

According to another embodiment, an individual receives advertisements based on information available from third party social networks. For example, FIG. 19 shows a page from an individual's third party social network, for example Facebook® page 1901. Posts on the individual's page come from various sources, friends' updates, news feed, and the individual's postings. It is a friend's birthday and a post appears 1902 on the individual's wall indicating so. The individual receives a communication, for example an email, indicating that it is his friend's birthday and suggests several items that he could buy as a birthday gift for his friend. Optionally, the individual receives advertisements for gifts for his friend based on his friends ‘likes’ or other information on his Facebook® page indicating his friend's preferences. For example, his friend may have posted that a particular theatre 1903 is enjoyable. The individual receives an email suggesting theatre tickets as a birthday gift for his friend. Alternatively, instead of email another form of electronic communication is employed.

According to another embodiment of the invention an individual receives advertisements based on information available from a friend's timeline. For example, friends of an individual are getting married. As shown in FIG. 20, a wedding event timeline 2000 is created and the bride, groom, friends and family have joined the wedding event and have access to the wedding event timeline 2000 of the bride and groom. One of the experiences entered into the wedding event timeline is the night of the bride and groom's engagement 2001. The groom proposed at their favorite restaurant. An up and coming sub-event within the wedding event timeline is an engagement party 2002. The individual receives communications prior to the engagement party, for example emails or other electronic communications, with suggestions for gifts for the bride and groom's engagement. One of the suggestions includes a gift certificate at the restaurant where the couple was engaged. Alternatively, when the individual goes to purchase a gift certificate at that restaurant, they are upsold, based on the cost of the engagement dinner, a more expensive gift certificate.

According to another embodiment groups of friends are targeted with ads based on the group behaviour. For example as shown in FIG. 21, an individual 2100 decides to go for a drink before a hockey game event. He sends a notice to all the friends 2101 that have joined the event inviting them to have a drink. Each friend optionally confirms or refuses the invitation. The invitation and response is entered into each friend's timeline, which is stored in the event data store 2101. For each hockey game event the individual attends, the individual 2100 sends out invitations to friends to meet for drinks and usually the same friends accept his invitation. The group of drinking friends are targeted with ads from bars close to the hockey arena and with restaurant promotions. Each member of the group receives the same or different communications from marketers. The ads are displayed, for example, on the friends' mobile devices. Optionally, the ads have a ‘call to action’, enticing an individual to immediately make a purchase through the ad displayed on, for example, the individual's mobile device. For example, a button is shown in the ad viewed on mobile device display that an individual presses to purchase for items such memorabilia, beer, and food. Alternatively, the ‘call to action’ entices the individual to add the individual's name to a group reservation, make a bid during an online auction or any other action taken by the individual as discussed above.

In another example, a group of 3 friends attend many of a hockey team's games, both home and away games. The group checks into the events by scanning their tickets. Their seat information is entered into their timelines, which is available to the social network and their other friends. The frequency at which they attend the team's games flag them as potential purchasers of season tickets for the following year. All 3 receive a communication, for example an email, offering a package deal on 3 season tickets for a reduced price. Further, when they join away games, they receive advertisements for lodging and food proximate the away game venue.

In yet another example, a more complex model of friend interactions is constructed based on the behaviours and interrelations between friends in order to formulate groups within groups of individuals that are likely to purchase or take a service together. For example, each of 30 friends seeks to purchase 12 tickets for an upcoming season. The friends are divided into 7 groups by the system based on past behaviour at events. For example, 10 of the friends often go to a sports bar together after a game while 7 friends typically go to an expensive restaurant. The groups need not be mutually exclusive as one or more members of the group going to the sports bar could also be part of the group going to expensive restaurants. This group related behaviour is used to offer tickets to the individuals as well as to schedule the offerings so that the friends can sit together in determined groups and interact. Perhaps an individual has 6 games with the sports bar crowd and 6 games with the restaurant crowd. Thus, the individual enjoys both groups. Similarly, another individual in the restaurant crowd may also enjoy dining before a game and may be apportioned between those groups as well. In this way, the 12 ticket packages can be quite flexible as to dates, teams, and so forth while being well suited to getting the group of individuals together in a meaningfully social atmosphere.

Of course, once the meaningful social atmosphere is created, the system optionally upsells individuals on another event or game where they are currently not in attendance but one of their groups is planning to attend.

Similarly, another process acts to upsell individuals on seats within an event. For example, two courtside seats to a basketball game are empty. A notice is sent to the ticket holder but, alas, he is unable to attend. The venue offers the seats to friends of the person sitting next to the vacant seat and already present at the event for a fee. Optionally, the fee is shared between the venue and the original ticket holder. A similar process is also employable before a game. When someone finds out that they will be unable to attend an event, the venue can sell for them their ticket to another party. Optionally the reselling is based on those sitting in proximity to the ticket. Alternatively, the selling is based on prior purchase and event attendance data.

In an embodiment, the data relating to activities of individuals is collected as part of a loyalty program wherein an individual receives a benefit for participating in the form of loyalty points or bonus offers. The data is collected to determine an individual's status within the program. For example, an individual opts into a loyalty program. Movement data relating to the individual and their whereabouts within a venue at different events is tracked. The movement data is used to better plan events to ensure easy and convenient access to services during an event. It is also used to provide location based services offering the individual goods and services and other offers. For example, the user always turns right upon exiting the seating area in order to purchase a beer. To the left is a more convenient beer stand with other related products. The user is prompted to try the other beer stand because it is closer. Alternatively, before intermission the individual is prompted to try a slice of piping hot pizza because it is known that the pizza stand is on the return path from the men's' room where the individual is likely heading. Of course, with historical movement data many other offerings are available. In an embodiment, the data relating to activities of individuals is collected as part of a fanclub program wherein an individual subscribes to fanclubs and fanclub activities and offers in relation to one or more events. For example, the first individual is a fan of number 16 and joins their “fan club.” As a member of the fan club, the first individual receives special updates relating to number 16 and special offers as well. Further, the first individual is provided with news tailored around their preferred players before, during and after games.

According to an embodiment of the invention, demographic information of an individual sitting in a particular seat is collected in a social network data store. Although the seat ticket is originally purchased by a first individual but used by a second individual, or the ticket is originally purchased by a company and used by employees or clients, demographics are collected on the individual actually sitting in the seat at the event venue during the event. Collecting demographics of each individual attending an event provides data for determining correlations within the demographic information. The correlations are used for targeting individuals who fall into certain demographic categories with particular ads. For example, a first correlation found in the demographic information is that men prefer beer as their alcoholic beverage of choice. A second correlation found in the demographic information is that women prefer coolers as their alcoholic beverage of choice. Based on this information, beer ads are sent to men and cooler ads are sent to women. A third correlation found is that men who sit in seats that are purchased by a company prefer imported beer over domestic beer as their alcoholic beverage of choice. Whereas a fourth correlation found is that men who sit in seats purchase by an individual prefer domestic beer over imported beer as their alcoholic beverage of choice. Based on this information, imported beers ads are sent to those men sitting in seats purchased by a company and domestic beers ads are sent to those men sitting in seats purchased by an individual. Other correlations are based on the demographics of all individuals that sat in a particular seat.

Demographics are also collected on individuals that have checked into an event but are not attending the event at the event venue. Correlations between individuals attending the event at the event venue and individuals checked into the event at other locations are determined. For example, individuals checked into the event at a location other than the event venue are most likely to be located in a sports bar during the event. Those individuals that attend the event at the event venue frequent a bar and grill after the event is finished. Based on this information, individuals checked into the event at a location other than the event venue are targeted with ads featuring sports bars and the individuals attending the event at the event venue are targeted with ads featuring bar and grills.

Numerous other embodiments may be envisaged without departing from the scope of the invention.

What is claimed is:

1. A method comprising:
joining an event by a first individual having an electronic communication device in communication with a communication network, joining the event other than joining a social network;
gathering individual event data within an event timeline, the individual event data in relation to the event and the first individual;
storing the individual event data in a data store in relation to the first individual and the event timeline;
based on the individual event data in the data store, retrieving advertisements from a server in communication with the communication network, the server having access to the individual event data in the data store; and
providing the advertisements to the electronic communication device and directed toward the first individual.

2. The method according to claim 1 comprising:
displaying by the electronic communication device the advertisements.

3. The method according to claim 2 comprising:
providing a call to action within the advertisement, the call to action for initiating a further action in response thereto, the further action effected remotely via the communication network.

4. The method according to claim 3 wherein the further action comprises a monetary transaction portion wherein the first individual spends money in response to the call to action.

5. The method according to claim 3 wherein the call to action relates to a memorabilia item, the memorabilia item relating to the event.

6. The method according to claim 5 wherein the memorabilia item is selected based on data stored in relation to the first individual.

7. The method according to claim 1 wherein individual event data comprises movement data relating to the first individual's movements about the event.

8. The method according to claim 1 wherein individual event data comprises seat data relating to a seat in which the first individual is intended to sit during the event.

9. The method according to claim 1 wherein individual event data comprises data relating to friends of the first individual who have also joined the event.

10. The method according to claim 1 wherein individual event data comprises event data relating to the first individual and stored in relation to at least a previous event.

11. The method according to claim 1 wherein individual event data comprises movement data relating to the first individual's movements about previous events.

12. The method according to claim 1 wherein individual event data comprises fan club data for the first individual.

13. A method comprising:
joining an event by a first individual having a first electronic communication device in communication with a communication network;
joining the event by a second individual having a second electronic communication device in communication with the communication network;
storing event data relating to the second individual and different from event data relating to the first individual;
based on event data within an event data store, retrieving advertisements from a server in communication with the communication network, the server having access to the event data, the advertisements based on at least the event data relating to the second individual; and
transmitting the advertisements to the first electronic communication device of the first user.

14. The method according to claim 13 wherein the event data comprises an indication that the first individual and the second individual joined the event.

15. The method according to claim 14 wherein the event data comprises data stored in a third party social network to which the second individual subscribes.

16. The method according to claim 14 wherein the event data comprises communication data between the second electronic communication device and the first electronic communication device.

17. The method according to claim 13 comprising transmitting the advertisement to friends of the first user who have joined the event.

18. The method according to claim 14 wherein transmitting the advertisements comprises transmitting the advertisements prior to a sub-event.

19. The method according to claim 13 comprising:
displaying by the first electronic communication device the advertisements.

20. The method according to claim 19 comprising:
providing a call to action within the advertisement, the call to action for initiating a further action in response thereto, the further action effected remotely via the communication network.

21. The method according to claim 20 wherein the further action comprises a monetary transaction portion wherein the first individual spends money in response to the call to action.

22. The method according to claim 20 wherein the call to action relates to a memorabilia item, the memorabilia item relating to the event.

23. The method according to claim 22 wherein the memorabilia item is selected based on data stored in relation to the second individual.

24. The method according to claim 13 wherein individual event data comprises movement data relating to the second individual's movements about the event.

25. The method according to claim 13 wherein individual event data comprises event data relating to the second individual and stored in relation to at least a previous event.

26. The method according to claim 13 wherein individual event data comprises the second individual's fan club data.
